(19) United States
(12) Patent Application Publication
(10) Pub. No.: US 2018/0300767 A1
(43) Pub. Date: Oct. 18, 2018

(54) COMPUTER-BASED SYSTEMS, APPARATUSES AND METHODS FOR A SOCIAL MEDIA PLATFORM FOR PROCESSING INTERNET TRAFFIC THROUGH ADVERTISING REVENUE

(71) Applicant: SNIPS MEDIA, LLC, Chicago, IL (US)

(72) Inventors: David Zaretsky, Chicago, IL (US); Fred Stan Hunting, III, West Simsbury, CT (US); Brandon Guttman, Cincinnati, OH (US)

(21) Appl. No.: 15/821,074

(22) Filed: Nov. 22, 2017

Related U.S. Application Data
(63) Continuation of application No. 14/216,609, filed on Mar. 17, 2014, now abandoned.
(60) Provisional application No. 61/790,219, filed on Mar. 15, 2013.

(51) Int. Cl. G06Q 30/02

(52) U.S. Cl. CPC G06Q 30/0275

(57) ABSTRACT

Integrated ad serving technology for utilizing real-time bidding to maximize revenue for each ad impression, based on cost-per-thousand (CPM), cost-per-click (CPC), or other factors. The ad serving technology may communicate in real-time with various ad networks, ad exchanges, real-time bidding platforms, and direct advertisers simultaneously, and selects the highest paid advertisements to display to the visitor. An analytics engine provides detailed statistics and insight about audience engagement. Analytics provides discovery and communication of meaningful patterns in data. Especially valuable in areas rich with recorded information, analytics relies on the simultaneous application of statistics, computer programming and operations research to quantify performance. Analytics may be applied to business data, to describe, predict, and improve business performance, such as optimizing audience engagement, marketing optimizations, price and promotion modeling, predictive science, and fraud analytics.

### CROSS-REFERENCE TO RELATED APPLICATIONS

This application is a Continuation of co-pending U.S. application Ser. No. 14/216,609, filed Mar. 17, 2014, which claims the benefit of priority to U.S. Provisional Application No. 61/790,219, filed Mar. 15, 2013, to Zaretsky et al, titled “Computer-Based Systems, Apparatuses and Methods for a Social Media Platform for Processing Internet Traffic Through Advertising Revenue.” The above-referenced applications are incorporated herein by reference in their entireties. This application is also related, to U.S. Non-Provisional patent application Ser. No. 14/216,495, filed Mar. 17, 2014, to Zaretsky et al, titled “URL Shortening Computer-Processed Platform for Processing Internet Traffic,” which is also incorporated herein by reference in its entirety.

### TECHNICAL FIELD

The present disclosure is directed to a social media platform, or any similar or equivalent platform, that allows its users to monetize on the traffic their content generates through advertising revenue.

### BACKGROUND

Social media has become popularized to the point where it is ubiquitous in society. However, there has been insufficient advancement in the monetization, organization and processing of content within the social media realm. What is needed is a system that operates efficiently in obtaining and processing user and content data to be able to obtain and post content and calculate accurate monetization data for advertisement.

### SUMMARY

Pages in the social media are populated with one or more ad impressions of various sizes, including but not limited to user home pages, company pages, stores, forums, blogs, and chat rooms. The page owner, or publisher, earns revenue from the advertisements displayed to visitors. Advertisements can be displayed or replaced any time a visitor enters the page, when the page is refreshed, when a visitor interacts with the content on the page, or after a specified amount of time.

The integrated ad serving technology disclosed herein may be designed to utilize real-time bidding to maximize the revenue for each ad impression, based on cost-per-thousand (CPM), cost-per-click (CPC), or other factors. The ad serving technology may communicate in real-time with various ad networks, ad exchanges, real-time bidding platforms, and direct advertisers simultaneously, and selects the highest paid advertisements to display to the visitor. The user may be paid a commission or provided other value from this advertisement revenue. The monetary compensation from advertisement revenue can also be extended to any sort of consideration, including but not limited to rewards, prizes, coupons, trips, vacations, hotels, and points.

The technology disclosed herein also includes an analytics engine, which provides detailed statistics and insight about audience engagement. Analytics may be thought of as the discovery and communication of meaningful patterns in data. Especially valuable in areas rich with recorded information, analytics relies on the simultaneous application of statistics, computer programming and operations research to quantify performance. Analytics may be applied to business data, to describe, predict, and improve business performance, such as optimizing audience engagement, marketing optimizations, price and promotion modeling, predictive science, and fraud analytics.

Further scope of applicability of the present disclosure will become apparent from the detailed description given hereinafter. However, it should be understood that the detailed description and specific examples, while indicating preferred embodiments, are given by way of illustration only, since various changes and modifications within the spirit and scope of the invention will become apparent to those skilled in the art from this detailed description.

### BRIEF DESCRIPTION OF THE FIGURES

The present disclosure will become more fully understood from the detailed description given hereinbelow and the accompanying drawings which are given by way of illustration only, and thus, do not limit the present disclosure, and wherein:

FIG. 1 illustrates an exemplary computer system under one embodiment comprising a user computer and mobile device operatively coupled to network, which is operatively coupled to a back-end server arrangement and content server;

FIG. 2 illustrates an exemplary content page comprising advertisements populated within ad zones of various sizes and positions on the page in one embodiment;

FIG. 3 illustrate an exemplary analytics page for links under one exemplary embodiment;

FIG. 4 illustrates an interactive visual graph structure, allowing a user to visually see actions or happenings that occur within a network, or those that occur just outside of the immediate network with varying degrees of separation, where the interactive graph structure can be a still or a moving graph that reacts to movement through any interaction, such as dragging, touching, clicking, moving, bumping, or through mechanical or electrical stimuli such as force feedback and gyros under various embodiments;

FIG. 5 illustrates an analytics report for a content page utilizing Scalable Vector Graphics (SVG) to present the traffic analytics graphs in an interactive manner under one exemplary embodiment;

FIG. 6 illustrates an exemplary Weibull plot for analytics under one embodiment, where slope of line is e probability of survival, S_{β}, is 36,8 percent at which L/L_{β}=1;

FIG. 7 illustrates an exemplary Weilbull plot for average ads to visits (APV) under one exemplary embodiment;

FIG. 8 illustrates a multi-level referral database that can track the referrals from all users up to any number of levels, wherein the multi-level referral tracks how a user joined a program through referral links, under one exemplary embodiment;

FIG. 9 illustrates an ad serving methodology under one exemplary embodiment, and may be utilized to form one or more content pages described above in connection with FIG. 2; and

FIG. 10 illustrates a string matching process based on the Aho-Corasick patterer matching under one exemplary embodiment.

### DETAILED DESCRIPTION

The figures and descriptions provided herein may have been simplified to illustrate aspects that are relevant for a clear understanding of the herein described devices, systems, and methods, while eliminating, for the purpose of clarity, other aspects that may be found in typical devices, systems, and methods. Those of ordinary skill may recognize that other elements and/or operations may be desirable and/or necessary to implement the devices, systems, and methods described herein. Because such elements and operations are well known in the art, and because they do not facilitate a better understanding of the present disclosure, a discussion of such elements and operations may not be provided herein. However, the present disclosure is deemed to inherently include all such elements, variations, and modifications to the described aspects that would be known to those of ordinary skill in the art.

Furthermore, it should be understood by those skilled in the art that, while the present disclosure discusses various embodiments that may include software, each of the embodiments comprising software are configured to operate on a tangible medium, such as a memory. Furthermore, reference is made in this disclosure to concepts, such as monetization, advertisement and the like, which may be interpreted by some as business methods. While in some cases the practice of these concepts provides some business-related benefit, the primary inventive features behind such concepts lie in the techniques and configurations used to more efficiently transfer and process computer data in computer systems.

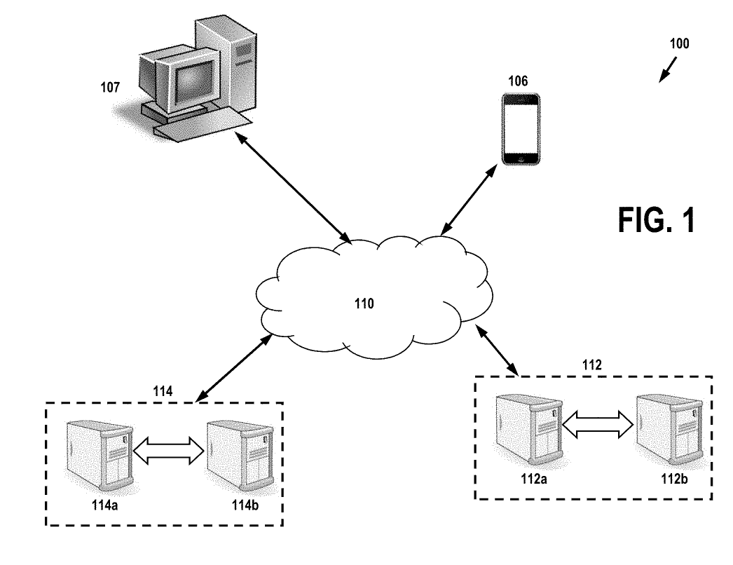

Turning to FIG. 1, an exemplary computer system 100 is disclosed comprising a user computer 107 and mobile device 106 operatively coupled to network 110. Computer 107 may be any suitable device capable of communicating data, such as packet data, over a wired or wireless medium. Examples include, but are not limited to, a personal computer, laptop, or workstation. Mobile device 106 similarly is configured to communicate data over a wired or wireless medium to network 110, and may include such devices as smart phones, tablets, and the like. Network 110 is also operatively coupled to back-end server arrangement 112, which may comprise one or more servers (112a-b) that may be directly linked or linked together via separate networks (e.g., LAN, WAN, etc.). Similarly, Network 110 is also operatively coupled to content server(s) 114, which may comprise one or more servers (114a-b) that may be directly linked or linked together via separate networks (e.g., LAN, WAN, etc.).

Content servers 114 may be configured to provide content (e.g., media, advertisements, text, etc.) requested by one or more users via devices 106-107, or any similar devices that may be in communication with network 110. Back-end server arrangement 112 may be configured in certain embodiments to provide features such as processing link shortening, sharing links, managing links, link redirect process, searching, account management, managing advertisements, traffic analytics, click-through rate processing and analysis, monetization score and rank, processing multi-level referrals, providing ad serving platform, processing targeted advertisements, security features, providing application programming interfaces, which are discussed in greater detail below. Back-end server arrangement 112 may also perform these functions with data from content servers 114. In certain embodiments, back-end server arrangement 112 and content servers 114 may shared responsibility for the aforementioned features. In other embodiments, back-end server arrangement 112 and content servers 114 may be combined into one network to perform all of such features.

Social media refers to the means of interactions among people in which they create, share, discuss, modify user-generate content, and exchange information and ideas in virtual communities and networks communities. It introduces substantial and pervasive changes to communication between organizations, communities and individuals.

Social media technologies can exist in different forms including magazines, Internet forums, weblogs, social blogs, microblogging, wikis, social networks, podcasts, photographs or pictures, video, rating and social bookmarking. They can run on different technology platform, in software or hardware, on mobile or desktop web-based platforms, as a web application, mobile application, or a software application compiled into byte code.

This social media platform is unique from other social media in that it allows its content publishers to get paid for the social value and traffic their content generates through advertisement revenue. A publisher can upload and/or share content with his followers or friends using this platform, including but not limited to websites, files, music, images, photos, and videos. The content can be stored on any web domain, cloud server platforms, or any hardware or software physical or abstract medium that can be accessed via any application protocol, including but not limited to HTTP, SSH, TCP/IP, and UDP. Like other social media, the content can be managed and organized into folders or groups. They can be tagged and assigned titles, descriptions, dates, and other meta information.

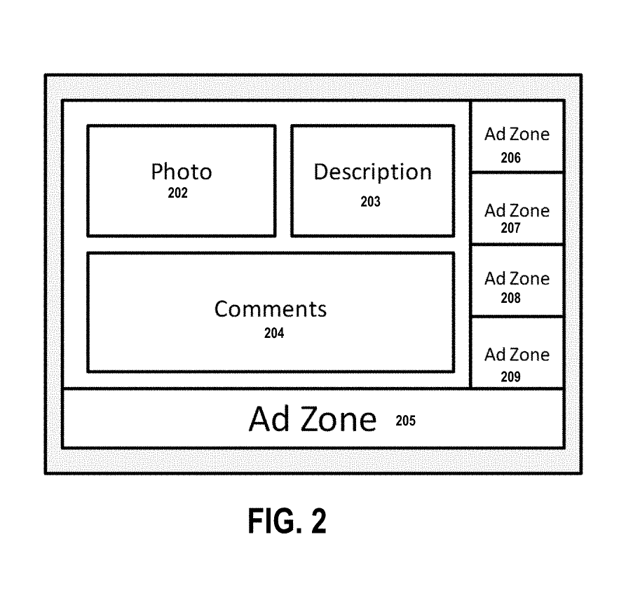

Pages in the social media are populated with advertisements, including but not limited to user home pages, company pages, stores, forums, blogs, and chat rooms. The page owner, or publisher, earns revenue from the advertisements displayed to visitors. The advertisements are populated inside ad zones (205-209), as illustrated in FIG. 2 that may appear alongside content including photos 202 description 203 and comments 204. Ad zones can be of various sizes and located in various positions on the page. Each ad zone may show one or more ad impressions of various sizes. The ad impressions can be displayed or replaced any time a visitor enters the page, when the page is refreshed, when a visitor interacts with the content on the page, or after a specified amount of time. Ad impressions can also be displayed upon entry or exit from a page as a pop-up, pop-under, or full page interstitial advertisement.

The advertisements can be hosted on any domain or platform. The system's ad serving technology is optimized to produce the highest paying advertisements by comparing the CPM values returned from various sources, including but not limited to ad networks, ad exchanges, and direct advertisers.

Publishers can also earn revenue by promoting or advertising products on their profile (home page), for example by posting to their comments 204. Advertisers can promote opportunities for advertising to individual on the social media site. Publishers can choose to promote different products on their page to share it with their friends and followers. For example, a publisher can write on their profile (203) or comments 204, “Buy a pair of these awesome Nike shoes,” which includes a hyperlink to the product and a picture. The hyperlink also contains an embedded personal code that when clicked by a visitor will earn the publisher revenue for advertising the product.

In one exemplary embodiment, with each visit to a page on the social media, analytics are gathered about the visitor. This information is derived from various client data, including but not limited to the IP address, HTTP user-agent, HTTP headers, Ethernet MAC address, and tracking cookies stored in the client's browser. The type of information derived from these data segments include but not limited to the client browser, operating system, application versions, installed programs and application plugins, and referring websites. The IP address may be used to perform geo-location lookup for city, state, country, and zip-code. The browser cookies may be used to track returning visitors by maintaining a list of pages that a client has visited. If the page is subsequently found in the cookie when it is read back, it implies they have previously visited that particular page. All of this information may be gathered and stored into a database, such as MySQL, for easy look up. The information can then be presented to the user in an easy to read format.

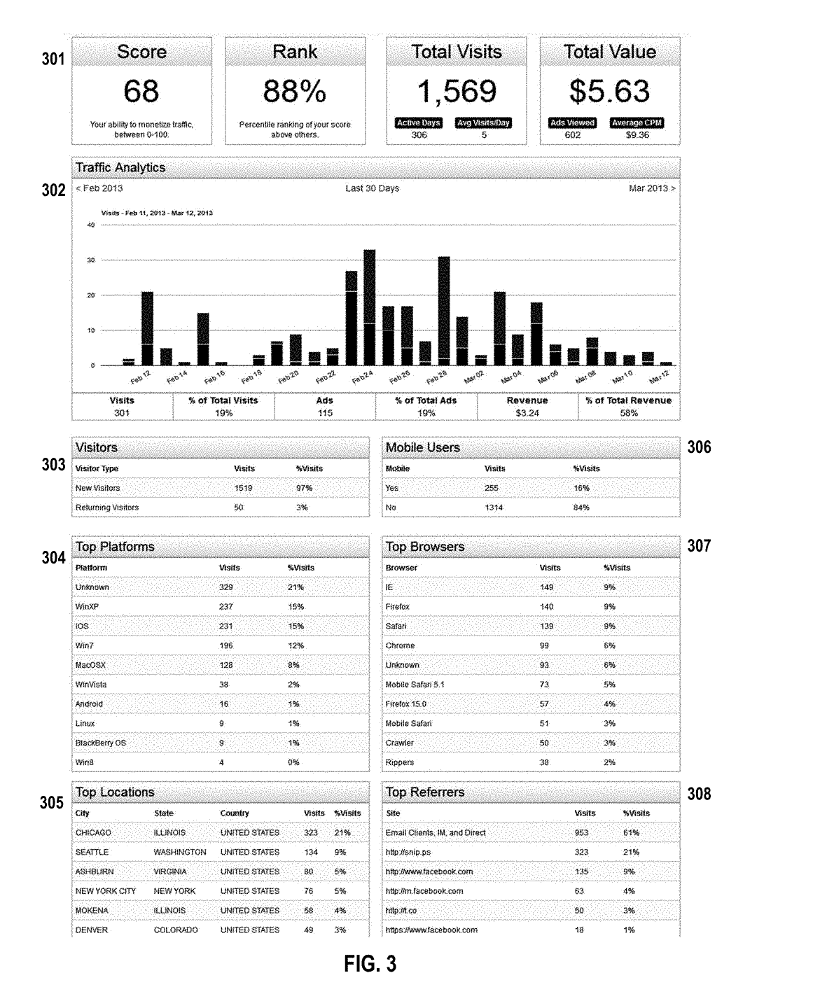

The analytics may be presented to the user in real-time as soon as the information is available. The analytics data may be acquired on a per page basis, so there is deeper insight into audience engagement. Exemplary statistics for a particular page is illustrated in FIG. 3. It also presents a user's score and rank compared to the rest of the population.

### (A) Managing and Sharing Content

A publisher can manage and share any content on this social media platform. Content types that can be posted to the social media include but not limited to websites, music, images, photos, and videos. The content can be stored or hosted on any web domain, cloud server platforms, or any hardware or software platform that can be accessed through application protocols, including but not limited to HTTP, SSH, TCP/IP, and UDP. The content can be shared in any physical form or as an abstract medium, such as a URL, a binary format, compressed format, barcode, or Quick Response (QR) codes that may be read by an imaging device, such as a mobile camera or scanner, that redirect the visitor to the destination page.

A publisher has the ability to add, remove, edit, delete, manage, and customize his content. He also has the ability to control advertisements on his pages, including enabling or disabled advertisements per page, or the type of advertisements. If advertisements are disabled, the publisher does not receive revenue because no advertisements are shown.

### (B) Communicating and Exploring

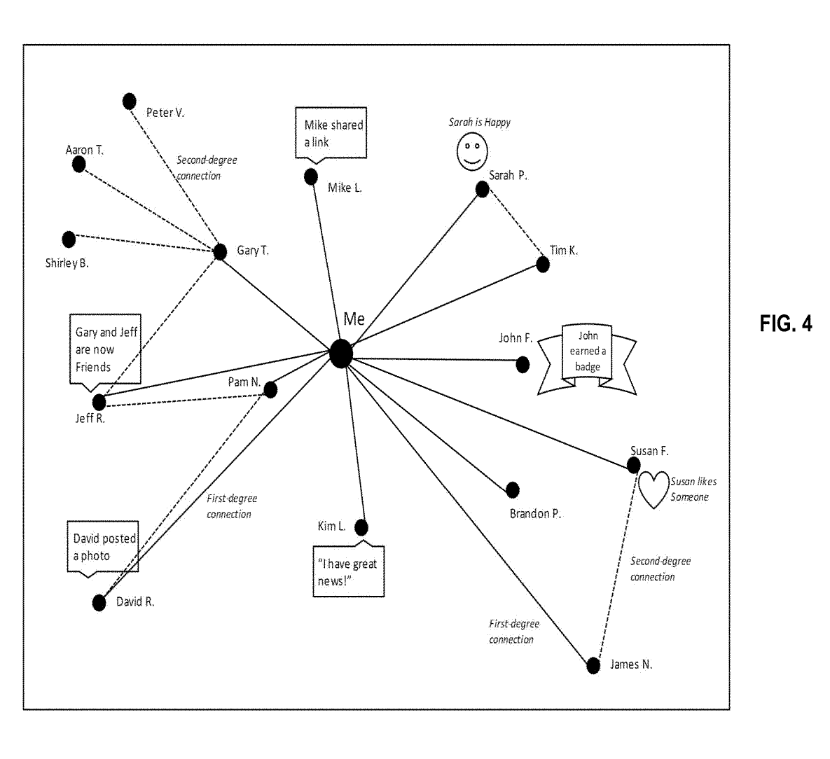

This social media technology presents a new way of communicating with individual inside and outside of a network through an interactive visual graph structure, as illustrated in FIG. 4. The embodiment allows one to visually see actions or happenings that occur within a network, or those that occur just outside of the immediate network with varying degrees of separation. The interactive graph structure can be a still or a moving graph that reacts to movement through any interaction, such as dragging, touching, clicking, moving, bumping, or through mechanical or electrical stimuli such as force feedback and gyros.

The graph nodes may represent individuals, businesses, pages, groups or other social network elements. Direct first-degree connections can be expressed as a solid line or a particular color, whereas a second-degree or more of separation can have dotted lines or another color. Events within a network appear as popup icons and messages. Examples include but are not limited to new connections, status updates, posting or sharing content, changes in relationship, earning badges or merits, changes in employment, comments, communication, or instant messaging.

There are many feasible ways of implementing such a graph structure. It can be implemented in software as server side scripts (e.g. PHP, Ruby on Rails), client side scripts (e.g. JavaScript, ASP, or AJAX), compiled software into byte code (e.g. C, C++, Java), general scripting languages (Python, Ruby, Pearl, Shell), or mobile applications. The common method would be to utilize Scalable Vector Graphics (SVG) to present the graphs in an interactive manner. SVG may bean XML-based vector image format for two-dimensional graphics that has support for interactivity and animation. SVG may be support, by virtually all client web browsers. As an example, the SVG code could run on the client browser, and would send update requests to a server that would be respond with updated events.

A visitor can interact with individuals and followers within the network by interacting or clicking on the nodes in the graph. For example, clicking on the node of an individual would open their profile, or clicking on a status update would open the context of the message. Individuals can also send pop-up messages to each other by interacting with the nodes, for example by double-clicking a node. User desktop and mobile applications can be built around the interactive visual graph with an open application programming interface to allow more interesting and custom interactions.

### (C) Account Management

A user account may include includes various fields to better identify a person and their followers. It also helps in generating analytics and optimizing targeted advertisements by determining the demographics of a person and/or their followers. For instance, their age range, gender, and likes. The user account includes but is not limited to the following:
1. User ID
2. Email address
3. Profile picture
4. Sign up for newsletters and updates
5. Mailing address
6. Phone number
7. Preferred payment method
8. Gender
9. Age
10. Security and account settings
11. Social media handles
12. OAuth access to social media to obtain their number of followers
13. Ad management controls

### (D) Managing Advertisements

From their account, publishers can manage advertisements on their pages, including:
1. Enabling or disabling advertisements. if disabled, then advertisements are not shown to visitors and the publisher does not earn revenue.
2. Enabling or disabling non-branded ad campaigns, If non-branded ad campaigns are disabled, run-of-network advertisements are never included in the real-time bidding for ad impressions, and these advertisements are never displayed to visitors. Rather, only branded ad campaigns that are specifically set up to target this individual are displayed. If a branded ad campaign is not available, no ad impression is displayed to the visitor.
3. Enabling or disabling rich-media advertisements only. If enabled, text-based advertisements will not show. Rather only high quality images and animated. advertisements (such as Flash or GIF) are displayed.
4. Enabling or disabled specific networks. The user can choose to allow only advertisements from specific ad networks, ad exchanges, or direct advertisers.
5. Specifying categories. The user can select certain categories of targeted advertisements for his audience to display or not to display. For instance, one may wish to only display ads pertaining to cars for his audience. Or, one may wish to not have ads displayed about certain subject matters.

### (E) Traffic Analytics

The traffic analytics engine provides powerful real-time analytics and insight to gauge audience reach. The analytics are attributed to each page or post independently to provide more fine-grain insight into the audience engagement. The traffic analytics may be derived from various data points including the IP address, HTTP user-agent, and HTTP referring website. The following methods are used to acquire data for the traffic analytics:
1. HTTP_REFERER—When visiting a webpage, the referrer or referring page may be the URL of the previous webpage from which a link was followed. This data may be acquired from the HTTP header field, HTTP_REFERER.
2. HTTP_USER AGENT—When a software agent operates in a network protocol, it often identifies itself, its application type, operating system, software vendor, or software revision, by submitting a characteristic identification string to its operating peer. In HTTP protocols, this identification may be transmitted in a header field HTTP_USER_AGENT. We utilize the Browscap module (http://www.browserscap.com) to download and maintain a local active MySQL database of all known user agents. The Browscap data may be already parsed to include information such as operating system, browser, versions, web crawlers, hots, and mobile platforms. A match can be found very quickly by querying the database as follows:
SELECT * FROM {browscap} WHERE :useragent LIKE useragent ORDER BY LENGTH(useragent) DESC
3. IP ADDRESS—Geolocation lookup may be used to deduce the geographic location of a visitor to a website. The approach is to use the client's IP address to look up their location through a database or third-party query tool. There are a number of free and paid subscription geolocation databases, ranging from country level to state or city—including ZIP/post code level—each with varying claims of accuracy (generally higher at the country level). One may utilize this method under the present disclosure to obtain the Country, State, and City for each visitor to a particular page. If a visitor is logged in, their account would provide accurate details on their city, state and country, which can be utilized in place of geo-ip lookup.

An exemplary storage method for the traffic analytics engine is described in Table 1 through Table 12 under various embodiments. These methods can be extended to store information about other traffic demographics, such as age, gender, and click-through rates. The tables are organized to provide optimal functionality in storing and retrieving the analytics data, as follows:
1. Paths—Table 1 maps a webpage's path to a unique ID (pid). It also includes a reference to the user ID. Given a path, the pid can be retrieved with the following query:
SELECT pid FROM {traffic_analytics paths} WHERE BINARY path=:path
2. Summary—Table 2 maps a path ID to the total number of visits, ad impressions displayed, and total revenue for that particular page. From this data, we can derive the average daily visits to the publisher's pages (visits/days), and the average cost-per-thousand ad impressions (value*1000/ads). Given the pid, these values can be retrieved with the following query:
SELECT visits, ads, value FROM {traffic_analytics_summary} WHERE pid=:pid
3. Visits
4.
5.
6. Table 3 maps a path II) to the total number of visitors for that particular page on any given date. Given the pid, the number of visits can be retrieved with the following query:
SELECT count FROM {traffic analytics visits} WHERE pid=:pid AND date=:date
7. Returning Visitors—Table 4 maps a path ID to the total number of returning visitors for that particular page. Given the pid, the number of returning visitors can be retrieved with the following query:
SELECT count FROM {traffic analytics returning visitors} WHERE pid=:pid
8. Mobile—Table 5 maps a path ID to the total number of mobile users for that particular page. Given the pid, these values can be retrieved with the following query:
SELECT count FROM {traffic_analytics_mobile} WHERE pid=:pid
9. Ads—Table 6 maps a path ID to the total number of ad impressions displayed and revenue earned for that particular page on any given date. Given the pid, these values can be retrieved with the following query:
SELECT count, value FROM {traffic_analytics_ads} WHERE pid=:pid AND date=:date
10. Platforms
11.
12.
13. Table 7 maps a path ID to the various operating systems utilized by visitors to that particular page. Given the pid, the top values can be retrieved with the following query:
SELECT os, mobile, count FROM {traffic_analytics_platforms} WHERE pid=:pid ORDER BY count DESC
14. Browsers—Table 8 maps a path ID to the various web browsers utilized by visitors to that particular page. Given the pid, the top values can be retrieved with the following query:
SELECT browser, bot, count FROM {traffic_analytics_browsers} WHERE pid=:pid ORDER BY count DESC
15. Locations—Table 9 maps a path ID to the geolocations('city, state, country) for visitors to that particular page. Given the pid, the top values can be retrieved with the following query:
SELECT city, state, country, count FROM {traffic_analytics_locations} WHERE pid=:pid ORDER BY count DESC
16. Referring Websites
17. Table 10 maps a path ID to the top referring websites for that particular page. Given the pid, the top values can be retrieved with the following query:
SELECT referrer, count FROM {traffic_analytics_referrers} WHERE pid=:pid ORDER BY count DESC
18. Trending—Table 11 maps a path ID to the total number of visits for a particular page each day. This method can be used to promote the top visited pages, or trending pages. Given the pid, these values can be retrieved with the following query:
SELECT * FROM {traffic_analytics_trending} WHERE date>=:start AND date <=:end ORDER BY count DESC
19. User Summary—Table 12 maps a user ID to the total number of visits, ad impressions displayed, and revenue for that particular user. It also holds the score and rank of that user as compared with the entire population. Given the uid, these values can be retrieved with the following query:
SELECT visits, ads, value, score, rank FROM {traffic_analytics_users} WHERE uid=:uid
20. Population Statistics—Table 13 stores the median score and rank for the population each day. Given a date, these values can be retrieved with the following query:
SELECT score, rank FROM {traffic_analytics_population_stats} WHERE date=:date

TABLE 1
Database field entries for Traffic Analytics Paths

| | | | | Default |
|---|---|---|---|---|
| Field | Description | Type | Not Null | Value |
| pid | Unique path ID | Int | TRUE | 0 |
| uid | Unique user ID | Int | TRUE | 0 |
| path | Path | varchar(255) | TRUE | Empty |

TABLE 2
Database field entries for Traffic Analytics Summary

| | | | | Default |
|---|---|---|---|---|
| Field | Description | Type | Not Null | Value |
| pid | Unique path ID | int | TRUE | 0 |
| visits | Total number of visits | int | TRUE | 0 |
| ads | Total number of advertisements | int | TRUE | 0 |
| value | Total earnings from advertisements | float | TRUE | 0 |

TABLE 3
Database field entries for Traffic Analytics Visits

| | | | | Default |
|---|---|---|---|---|
| Field | Description | Type | Not Null | Value |
| pid | Unique path ID | int | TRUE | 0 |
| date | Timestamp for date of visit | int | TRUE | 0 |
| count | Counter for number of visits | int | TRUE | 0 |

TABLE 4
Database field entries for Traffic Analytics Returning Visitors

| | | | | Default |
|---|---|---|---|---|
| Field | Description | Type | Not Null | Value |
| pid | Unique path ID | Int | TRUE | 0 |
| count | Counter for number of returning | Int | TRUE | 0 |
| | visitors | | | |

TABLE 5
Database field entries for Traffic Analytics Mobile Platforms

| | | | | Default |
|---|---|---|---|---|
| Field | Description | Type | Not Null | Value |
| pid | Unique path ID | Int | TRUE | 0 |
| count | Counter for number of mobile users | int | TRUE | 0 |

TABLE 6
Database field entries for Traffic Analytics Ads

| | | | | Default |
|---|---|---|---|---|
| Field | Description | Type | Not Null | Value |
| pid | Unique path ID | int | TRUE | 0 |
| date | Timestamp for ad displayed | int | TRUE | 0 |
| count | Counter for number of ads | int | TRUE | 0 |
| value | Sum of earnings from ads | float | TRUE | 0 |

TABLE 7
Database field entries for Traffic Analytics Platforms

| | | | | Default |
|---|---|---|---|---|
| Field | Description | Type | Not Null | Value |
| pid | Unique path ID | int | TRUE | 0 |
| os | Operating system | varchar(64) | TRUE | Empty |
| mobile | Is it a mobile OS | int | TRUE | 0 |
| count | Counter for platforms | int | TRUE | 0 |

TABLE 8
Database field entries for Traffic Analytics Browsers

| | | | | Default |
|---|---|---|---|---|
| Field | Description | Type | Not Null | Value |
| pid | Unique path ID | int | TRUE | 0 |
| browser | Browser | varchar(64) | TRUE | Empty |
| bot | Is it a web crawler or bot | int | TRUE | 0 |
| count | Counter for platforms | int | TRUE | 0 |

TABLE 9
Database field entries for Traffic Analytics Locations

| | | | | Default |
|---|---|---|---|---|
| Field | Description | Type | Not Null | Value |
| pid | Unique path ID | int | TRUE | 0 |
| city | City | varchar(64) | TRUE | Empty |
| state | State or Region | varchar(64) | TRUE | Empty |
| country | Country | varchar(64) | TRUE | Empty |
| count | Counter for platforms | int | TRUE | 0 |

TABLE 10
Database field entries for Traffic Analytics Referers

| | | | | Default |
|---|---|---|---|---|
| Field | Description | Type | Not Null | Value |
| pid | Unique path ID | int | TRUE | 0 |
| referrer | Referral URL or Domain | varchar(255) | TRUE | Empty |
| count | Counter for number of | int | TRUE | 0 |
| | referrers | | | |

TABLE 11
Database field entries for Traffic Analytics Trending

| | | | | Default |
|---|---|---|---|---|
| Field | Description | Type | Not Null | Value |
| pid | Unique path ID | int | TRUE | 0 |
| date | Timestamp for date of visit | int | TRUE | 0 |
| count | Counter for number of visits | int | TRUE | 0 |

TABLE 12
Database field entries for Traffic Analytics Users

| | | | | Default |
|---|---|---|---|---|
| Field | Description | Type | Not Null | Value |
| uid | Unique user ID | int | TRUE | 0 |
| visits | Total number of visits | int | TRUE | 0 |
| ads | Total number of advertisements | int | TRUE | 0 |
| value | Total earnings from advertisements | float | TRUE | 0 |
| score | Score in terms of ability to monetize | int | TRUE | 0 |
| rank | Rank in terms of revenue earned | int | TRUE | 0 |

TABLE 13
Database field entries for Traffic Analytics Population Statistics

| | | | | Default |
|---|---|---|---|---|
| Field | Description | Type | Not Null | Value |
| date | Timestamp for ad displayed | int | TRUE | 0 |
| score | Score in terms of ability to monetize | int | TRUE | 0 |
| rank | Rank in terms of revenue earned | int | TRUE | 0 |

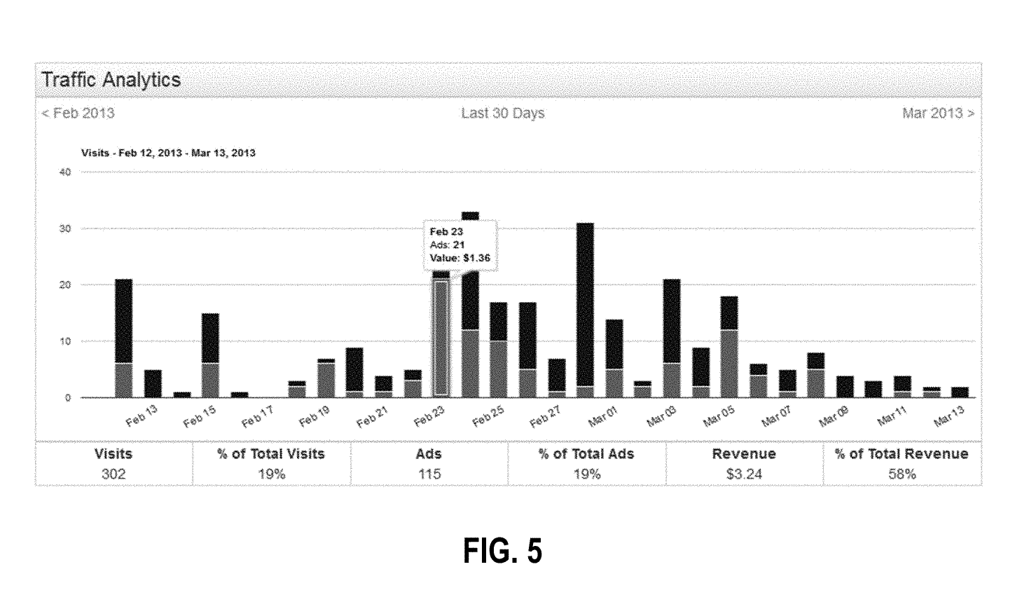

The exemplary methods described above are utilized to generate a traffic analytics report for each page, as illustrated in FIG. 5. In addition, we utilize Scalable Vector Graphics (SVG) to present the traffic analytics graphs in an interactive manner. SVG is an XML-based vector image format for two-dimensional graphics that has support for interactivity and animation. There are various methods to generate graph, either using a software program or by using third party tools, such as Google's Charts API. Error! Reference source not found. demonstrates the traffic analytics interactive graph. The number of daily ad impressions and total revenue may be overlaid on top of the total daily visits. By clicking on the bar, a pop-up window specifies the number of ads, the revenue, and the visits for that day. To generate this graph, we utilize the code base demonstrated in [EX1]. The key to making the ads overlay the visits may be by subtracting the ads from the visits in order to reduce the value, v, but the actual text field, f, may be specified as the original value. For example, on February 23 there were 27 visits and 21 ad impressions. The visits value may be set to v-27-21-6, while the text field may be set to 27.

One can navigate to any time frame in the graph by clicking a date range button, hyperlink, or navigation tab. The plot can be viewed by year, month, week, day, hour, minute, or second, depending on the level of fine grain detail stored in the database. This system stores long-term analytics data at the level of days, but also maintains a separate table to store data for the current day only at the level of seconds. This allows a user to zoom in and out to various date and time ranges. The tables holding the data at the level of seconds may be eliminated each day. A period summary may be also shown, which breaks down the number of visits, ad impressions, and revenue for that time period.

[EX1]: Google Charts API code for Traffic Analytics Graph

```
google.load(“visualization”, “1.0”, {“packages”:[“corechart”]});
google.setOnLoadCallback(drawChart);
function drawChart( ) {
var data = google.visualization.arrayToDataTable([
    [“Date”, “Ads”, “Visits”], [“”, 0, 0],
    [“Feb 12”, {v:6, f:“6\nValue: $0.02”}, {v:15, f:“21”}],
    [“Feb 13”, 0, 5],
    [“Feb 14”, 0, 1],
    [“Feb 15”, {v:6, f:“6\nValue: $0.03”}, {v:9, f:“15”}],
    [“Feb 16”, 0, 1],
    [“Feb 17”, 0, 0],
    [“Feb 18”, {v:2, f:“2\nValue: $0.01”}, {v:1, f:“3”}],
    [“Feb 19”, {v:6, f:“6\nValue: $0.03”}, {v:1, f:“7”}],
    [“Feb 20”, {v:1, f:“1\nValue: $0.00”}, {v:8, f:“9”}],
    [“Feb 21”, {v:1, f:“1\nValue: $0.00”}, {v:3, f:“4”}],
    [“Feb 22”, {v:3, f:“3\nValue: $0.01”}, {v:2, f:“5”}],
    [“Feb 23”, {v:21, f:“21\nValue: $1.36”}, {v:6, f:“27”}],
    [“Feb 24”, {v:12, f:“12\nValue: $0.90”}, {v:21, f:“33”}],
    [“Feb 25”, {v:10, f:“10\nValue: $0.68”}, {v:7, f:“17”}],
    [“Feb 26”, {v:5, f:“5\nValue: $0.02”}, {v:12, f:“17”}],
    [“Feb 27”, {v:1, f:“1\nValue: $0.00”}, {v:6, f:“7”}],
    [“Feb 28”, {v:2, f:“2\nValue: $0.01”}, {v:29, f:“31”}],
    [“Mar 01”, {v:5, f:“5\nValue: $0.02”}, {v:9, f:“14”}],
    [“Mar 02”, {v:2, f:“2\nValue: $0.01”}, {v:1, f:“3”}],
    [“Mar 03”, {v:6, f:“6\nValue: $0.03”}, {v:15, f:“21”}],
    [“Mar 04”, {v:2, f:“2\nValue: $0.01”}, {v:7, f:“9”}],
    [“Mar 05”, {v:12, f:“12\nValue: $0.05”}, {v:6, f:“18”}],
    [“Mar 06”, {v:4, f:“4\nValue: $0.02”}, {v:2, f:“6”}],
    [“Mar 07”, {v:1, f:“1\nValue: $0.00”}, {v:4, f:“5”}],
    [“Mar 08”, {v:5, f:“5\nValue: $0.02”}, {v:3, f:“8”}],
    [“Mar 09”, 0, 4],
    [“Mar 10”, 0, 3],
    [“Mar 11”, {v:1, f:“1\nValue: $0.00”}, {v:3, f:“4”}],
    [“Mar 12”, {v:1, f:“1\nValue: $0.00”}, {v:1, f:“2”}],
    [“Mar 13”, 0, 2]]);
    DrawChart = function( w, h, cw, ch, l, hfs, sp )
    {
        var options = {
            title: “Visits - Feb 12, 2013 - Mar 13, 2013”,
            width: w,
            height: h,
            chartArea: {width:cw,height:ch,left:1},
            fontSize: 10,
            legend: “none”,
            colors: [“green”, “blue”],
            isStacked: true,
            axisTitlesPosition: “none”,
            hAxis: {slantedText: true, minValue: 0, showTextEvery: sp,
            textStyle: {fontSize: hfs}},
            vAxis: {viewWindow: {min: 0}}
        };
        var chart = new
        google.visualization.ColumnChart(document.getElementById
        (“analytics-chart-div”));
        chart.draw(data, options);
    }
}
```

### (F) Click-Through Rate

Click-through rates (CTR) can be determined by comparing the number of visits to a particular post or page as compared with the size of their audience (followers). We define the click-through rate for a particular page or post as: CTR=R/N, where R is the number of times the page was visited, and N is the number of social followers for that individual on the social media site.

If a user supplies their account credentials to another social media site, such as Facebook or Twitter, using the OAuth method, for instance. The system can then acquire the total number of social followers for each social media. When a visitor arrives from one of these social media sites, the referral websites will accumulate in the traffic analytics. We can then define the click-through rate for a particular page as: CTR=R/N, where R is the number of times the social media domain appeared as the referring website for this page in the database (

Table 10), and N is the number of social followers for that user on that social media site. We can also use this information to obtain an average CTR for all social media, as well as an average CTR for all pages for a particular publisher.

### (G) Monetization Score and Rank

There are many industry platforms available that assess an individual's ability to influence others and platforms that determine the popularity of websites:

Alexa Rank (www.alexa.com) provides traffic data, global rankings, and other information about websites to determine its popularity. Once it is installed, the Alexa Toolbar collects data on browsing behavior and transmits it to the Alexa website, where it is stored and analyzed, forming the basis for the company's web traffic reporting. As of 2013, Alexa provides traffic data, global rankings and other information on 30 million websites, and claims that 6 million people visit its website monthly.

PageRank is a link analysis algorithm by the Google (www.google.com) web search engine that assigns a numerical weighting to each element of a hyperlinked set of documents on the internet, with the purpose of measuring its relative importance within the set. The algorithm may be applied to any collection of entities with reciprocal quotations and references.

The Klout score (www.klout.com) provides social media analytics to measure a user's influence across his or her social network. The analysis may be done on data taken from sites such as Twitter, Facebook, and Google+, and measures the size of a person's network, the content created, and purports to measure how other people interact with that content. Klout scores range from 1 to 100, with higher scores corresponding to a higher assessment by Klout of the breadth and strength of one's online influence. Klout scores are supplemented with three nominally more specific measures, which Klout calls “true reach,” “amplification,” and “network impact.” True reach may be based on the size of a person's “engaged audience” of followers and friends who actively listen and react to his or her online messages. Amplification score relates to the likelihood that one's messages will generate actions (retweets, messages, likes, and comments). Network score reflects the computed influence value of a person's engaged audience.

Kred Influence Measurement, or Kred, (www.kred.com) is a measure of influence created by PeopleBrowsr, a San Francisco-based social media analytics company, to identify influential people in interest-based communities. Kred scores are generated by observing a social network user's content, who it reaches, who acts upon it, and whether the user relays the content of others. Kred is given as a dual score to distinguish a person's Influence (the likelihood that someone will trust a person and act upon their posts) and Outreach (the propensity to share other people's content forward). Kred Influence measures a user's relative ability to inspire action from others like retweeting, replies, or new follows. Influence scores are delivered on a normalized 1,000 point scale with higher scores representing a higher degree of trust and influence within the network. Kred Outreach measures generosity and rewards actions like engagement with others and willingness to spread their message. Outreach is scored in ever-increasing levels and never decreases.

PeerIndex (www.peerindex.com) is a London-based company providing social media analytics based on footprints from use of major social media services (currently Twitter, Linkedin, Facebook and Quora). Part of an emerging group of Social Media Analytics providers, PeerIndex helps social media contributors assess and score their influence and benefit from the social capital they have built up. PeerIndex currently tracks 45 million Twitter profiles, making the company one of the leaders in its sector.

The Q Score (www.gscores.com) is a measurement of the familiarity and appeal of a brand, company, celebrity, or television show used in the United States. The higher the Q Score, the more highly regarded the item or person is among the group that is familiar with them. Q Scores and other variants are primarily used by the media, marketing, advertising and public relations industries.

This social media platform in accordance with the present disclosure is the first to introduce a Monetization Score and Rank which are used to calculate a user's ability to monetize traffic on the internet and social media. Because the advertisement revenue is directly correlated to the traffic generated by each page, one can accurately determine how well an individual can monetize traffic. While the other methods listed above evaluate individuals independently of others, this method calculates an individual's score based on how well the rest of the population performed. The reason for this is that there are many factors in the environment and economics that can change the behavior of entire populations. A score is more meaningful if an individual can assess how they are doing as compared with everyone else. Therefore, we utilize the percentile rank of an individual's score in various test factors to calculate the complete monetization score.

The monetization score may he calculated over each 30 day period, based on several weighted test factors, including (but not limited to):
R, the total revenue earned. This determines how well an individual performed in generating revenue over a 30 day period.
V, the average number of daily visits over a 30 day period. This measures the overall daily activity of an individual.
CPM, the average cost-per-thousand ad impressions (CPM=revenue*1000 ads). The CPM may be directly correlated to the interest level of the content being shared, since advertisers are generally more inclined to pay higher CPMs for relevant topics. Also, celebrities and athletes that have branded advertisements will earn higher CPMs.
APV, the average number of ads per visit (APV=ads/visits). The use of hots or web crawlers would not generate paid advertisements. Likewise, introducing software programs to click links or visit pages would also not generate paid advertisements. In effect, these schemes would increase the number of visits, but not the number of advertisements, and therefore would reduce the APV.

Each of these values are calculated for every individual in the population, and then given a rank, r, based on its percentile rank from 0-100%. A fractional weight, w, is then applied to each value and added together to receive the monetization score. The sum of all weights must equal 1.0, and they can be evenly distributed, or more heavily weighted on certain factors. Other factors can be easily added to the score as well, and then simply adjusting the weights. The monetization score, S, is defined as:

S=w_{R}*r_{R}+w_{V}*r_{V}+w_{CPM}*r_{CPM}+w_{APV}*r_{APV},

Where, w_{R}w_{V}+w_{CPM}+w_{APV}=1

The monetization score can be calculated by first updating the analytics for each individual over a 30-day period, as described in [EX2]. The data may be a summation of all visits, ad impressions displayed, and revenue generated. In [EX3], the score may be calculated for each factor as described above, and then ranked based on percentile within the entire population. We consider those individuals with no traffic or revenue as suspensions and are not evaluated in the score. Each factor then has a rank value between 0-100. In this case, an evenly distributed weight of 0.25 may be applied to each rank value. The resulting monetization score may he a value between 0-100. Finally, in [EX4], the percentile rank of the monetization score may be calculated for each individual.

[EX2]: Update user statistics over an n-day period

```
INSERT INTO {traffic_analytics_users} (uid, visits, ads, value)
SELECT t1.uid, SUM(t2.visits) as visits, SUM(t3.ads) as ads, SUM
(t3.value) as value
FROM {traffic_analytics_paths} AS t1
LEFT JOIN ( SELECT pid, date, SUM(count) AS visits
        FROM {traffic_analytics_visits}
        WHERE date > :start_date
        GROUP BY pid
    ) t2 ON (t1.pid = t2.pid)
LEFT JOIN ( SELECT pid, date, SUM(count) AS ads, SUM(value) AS
value
        FROM {traffic_analytics_ads}
        WHERE date > :start_date
        GROUP BY pid
    ) t3 ON (t1.pid = t3.pid)
GROUP BY t1.uid
```

[EX3]: Calculating the monetization score over an n-day period.

```
UPDATE {traffic_analytics_users} as t
JOIN (
    SELECT uid, value as revenue,
        @w_prev := @w_curr as w_prev,
        @w_curr := value as w_curr,
        @w_rank := IF(@w_prev > @w_curr, @w_rank+@w_ties,
        @w_rank) AS w_rank,
        @w_ties := IF(@w_prev = @w_curr, @w_ties+1,
        1) AS w_ties,
        (1-@w_rank/@w_total) as w_percentrank
    FROM
        {traffic_analytics_users},
        (SELECT
            @w_curr := null,
            @w_prev := null,
            @w_rank := 0,
            @w_ties := 1,
            @w_total := count(*) from traffic_analytics_users
            WHERE value IS NOT NULL AND value > 0
                AND ads IS NOT NULL AND ads > 0
                AND visits IS NOT NULL AND visits > 0
        ) a
        WHERE value IS NOT NULL AND value > 0
            AND ads IS NOT NULL AND ads > 0
            AND visits IS NOT NULL AND visits > 0
        ORDER BY revenue DESC
) w ON w.uid = t.uid
JOIN (
    SELECT uid, (value/ads) as cpm,
        @x_prev := @x_curr as x_prev,
        @x_curr := (value/ads) as x_curr,
        @x_rank := IF(@x_prev > @x_curr, @x_rank+@x_ties,
        @x_rank) AS x_rank,
        @x_ties := IF(@x_prev = @x_curr, @x_ties+1, 1)
        AS x_ties,
        (1-@x_rank/@x_total) as x_percentrank
    FROM
        {traffic_analytics_users},
        (SELECT
            @x_curr := null,
            @x_prev := null,
            @x_rank := 0,
            @x_ties := 1,
            @x_total := count(*) from traffic_analytics_users
            WHERE value IS NOT NULL AND value > 0
                AND ads IS NOT NULL AND ads > 0
                AND visits IS NOT NULL AND visits > 0
        ) b
        WHERE value IS NOT NULL AND value > 0
            AND ads IS NOT NULL AND ads > 0
            AND visits IS NOT NULL AND visits > 0
        ORDER BY cpm DESC
) x ON x.uid = t.uid
JOIN (
    SELECT uid, (ads/visits) as apv,
        @y_prev := @y_curr as y_prev,
        @y_curr := (ads/visits) as y_curr,
        @y_rank := IF(@y_prev > @y_curr, @y_rank+@y_ties,
        @y_rank) AS y_rank,
        @y_ties := IF(@y_prev = @y_curr, @y_ties+1, 1)
        AS y_ties,
        (1-@y_rank/@y_total) as y_percentrank
    FROM
        {traffic_analytics_users},
        (SELECT
            @y_curr := null,
            @y_prev := null,
            @y_rank := 0,
            @y_ties := 1,
            @y_total := count(*) from traffic_analytics_users
            WHERE value IS NOT NULL AND value > 0
                AND ads IS NOT NULL AND ads > 0
                AND visits IS NOT NULL AND visits > 0
        ) c
        WHERE value IS NOT NULL AND value > 0
            AND ads IS NOT NULL AND ads > 0
            AND visits IS NOT NULL AND visits > 0
        ORDER BY apv DESC
) y ON y.uid = t.uid
JOIN (
    SELECT uid, (visits/30) as activity,
        @z_prev := @z_curr as z_prev,
        @z_curr := (visits/30) as z_curr,
        @z_rank := IF(@z_prev > @z_curr, @z_rank+@z_ties,
        @z_rank) AS z_rank,
        @z_ties := IF(@z_prev = @z_curr, @z_ties+1, 1)
        AS z_ties,
        (1-@z_rank/@z_total) as z_percentrank
    FROM
        {traffic_analytics_users},
        (SELECT
            @z_curr := null,
            @z_prev := null,
            @z_rank := 0,
            @z_ties := 1,
            @z_total := count(*) from traffic_analytics_users
            WHERE value IS NOT NULL AND value > 0
                AND ads IS NOT NULL AND ads > 0
                AND visits IS NOT NULL AND visits > 0
        ) d
        WHERE value IS NOT NULL AND value > 0
            AND ads IS NOT NULL AND ads > 0
            AND visits IS NOT NULL AND visits > 0
        ORDER BY activity DESC
) z ON z.uid = t.uid
SET t.score =
ROUND((w.w_percentrank+x.x_percentrank+y.y_percentrank+
z.z_percentrank)*25, 0)
WHERE value IS NOT NULL AND value > 0
    AND ads IS NOT NULL AND ads > 0
    AND visits IS NOT NULL AND visits > 0
```

[EX4]: Calculating the percentile rank of the monetization score

```
UPDATE traffic_analytics_users as t
JOIN (
    SELECT uid, score as val,
        @prev := @curr as prev,
        @curr := score as curr,
        @rank := IF(@prev > @curr, @rank+@ties, @rank) AS rank,
        @ties := IF(@prev = @curr, @ties+1, 1) AS ties,
        (1-@rank/@total) as percentrank
    FROM
        {traffic_analytics_users},
        (SELECT
            @curr := null,
            @prev := null,
            @rank := 0,
            @ties := 1,
            @total := count(*) from traffic_analytics_users where
score is not null and score > 0
        ) b
        WHERE score is not null
        ORDER BY score DESC
) u ON u.uid = t.uid
SET t.rank = ROUND(u.percentrank * 100.0)
WHERE score > 0
```

In probability theory and statistics, the Weibull distribution may be a continuous probability distribution. W. Weibull originally developed a method and equation for statistically evaluating the fracture strength of materials. He also applied the method and equation to fatigue data based upon small sample (population) sizes, where the two-parameter expression relating life, L, characteristic life, L_{β} and probability of survival, S, is:

ln ln [1/S]−e ln [L/L_{β}], where 0<L<∞; 0<S<1

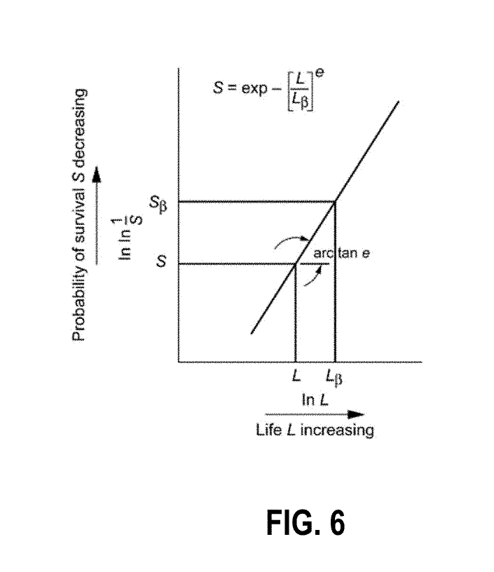

As can be seen from the exemplary embodiment of FIG. 6, when plotting the ln ln [1/S] as the ordinate against the in as the abscissa, fatigue data are assumed to plot as a straight line. The ordinate ln ln [1/S] is graduated in statistical percent of components failed or removed for cause as a function of ln L, the log of the time or cycles to failure. The tangent of the line is designated the Weibull slope e, which is indicative of the shape of the cumulative distribution or the amount of scatter of the data. The Weibull slope of the resultant Weibull plot approximates the statistical distribution of the data. As an example, a Weibull slope of 1 approximates an exponential distribution. A Weibull slope of 2 approximates a Raleigh distribution. A Weibull slope of 3.57 approximates a Gaussian or normal distribution. The resulting values of life compare reasonably well with other statistical distributions such as log normal. However, the ease of use and consistency of results offers an advantage of the Weibull method over these other distribution functions.

Using the Weibull method, we can determine for any given 30-day period what type of distribution to use for a particular test factor, as it is possible that these distributions may differ over time with changes in the population or the economy. Knowing this distribution factor, one can easily calculate the potential monetization score of an individual by simply adjusting certain factors. It can furthermore be utilized to advise individuals how to change certain factors to improve their score, such as by increasing daily activity, or focusing on specific websites that have shown to produce greater quality traffic.

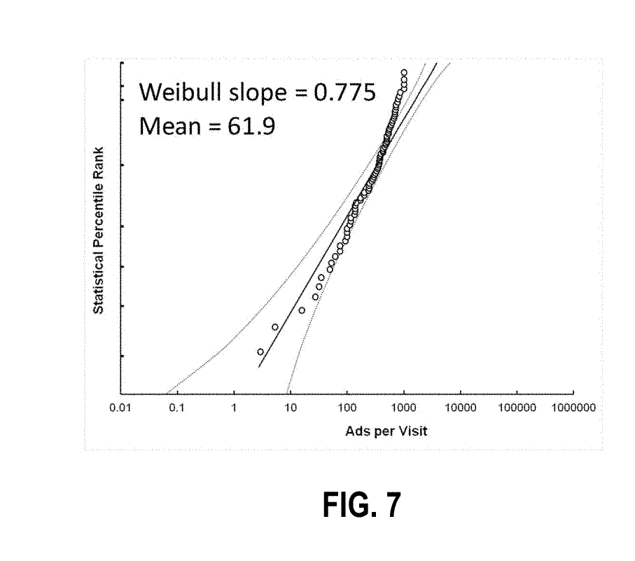

In the exemplary embodiment of FIG. 7, the Weibull plot for average ads per visit (APV) demonstrates a slope of 0.775 and statistical mean of 61.9 for the entire population. The daily statistical mean can be plotted in a line graph with the monetization score for each individual so they can view their performance with respect to others in the population. We can use the slope to calculate predicted scores based on changes in various test factors. For instance, we can then inform individuals that by increasing the number of ads per visit by n, it would increase their monetization score to Sₙ.

### (H) Multi-Level Referrals

When an anonymous visitor browses a publisher's page, a tracking cookie may be deposited in the client's browser with a unique identifier, which allows the software to track the user if they should return. The publisher's referral ID may be also deposited into the cookie. Should the visitor sign up within the expiration time of the referral cookie, they automatically become a referral of that publisher. The publisher receives commission on advertisements from their referrals.

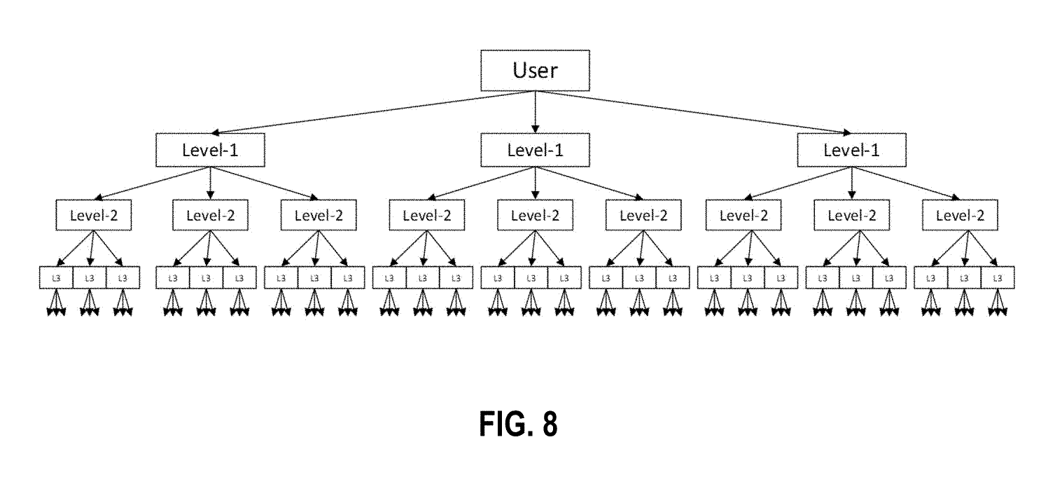

The system includes a multi-level referral database that can track the referrals from all users up to any number of levels. The multi-level referral tracks how a user joined the program through referral links, as illustrated in FIG. 8. A database may be used to store the relationship between referrals up to n levels, as required by the application. Table 14 shows the fields for the database table to store up to 10 levels of referral relationships.

The multi-level referrals works as follows:
1. An anonymous visitor browses a page on the social media site. A cookie may be dropped into the client's browser with the publisher's referral code and an expiration date, for example 30 days. The browser cookie may be never overwritten; it may be only replaced once it has expired.
2. If the visitor comes back to the social media site and joins, the system downloads the cookie from the client browser and checks for a referral code. If a referral code is found, the publisher II) for the referral code is determined.
3. An entry may be added to the multi-level referral table for the visitor (client) with ref level1 uid set to the referrer user ID.
4. The n-level referral IDs of the publisher may be obtained from the database, and loaded into positions 2 through n-1.
5. Each time the client generates revenue, a referral commission can be applied to any level of referrals in the hierarchy by simply performing a database lookup.

TABLE 14
Database fields for Multi-Level Referrals

| | | | Not | Default |
|---|---|---|---|---|
| Field | Description | Type | Null | Value |
| uid | The UID of the user | int | TRUE | 0 |
| | who was invited | | | |
| max_level | The max allowable | int | TRUE | 0 |
| | levels for | | | |
| | monetizing | | | |
| created | UNIX timestamp | int | TRUE | 0 |
| | when user registered | | | |
| host | Network address | varchar(255) | TRUE | Empty |
| http_referrer | URL of the referring | varchar(255) | TRUE | Empty |
| | site | | | |
| ref_level1_uid | The level-1 referrer | int | FALSE | 0 |
| ref_level2_uid | The level-2 referrer | int | FALSE | 0 |
| ref_level3_uid | The level-3 referrer | int | FALSE | 0 |
| ref_level4_uid | The level-4 referrer | int | FALSE | 0 |
| ref_level5_uid | The level-5 referrer | int | FALSE | 0 |
| ref_level6_uid | The level-6 referrer | int | FALSE | 0 |
| ref_level7_uid | The level-7 referrer | int | FALSE | 0 |
| ref_level8_uid | The level-8 referrer | int | FALSE | 0 |
| ref_level9_uid | The level-9 referrer | int | FALSE | 0 |
| ref_level10_uid | The level-10 referrer | int | FALSE | 0 |

### (I) Ad Serving Platform

Advertisements on the social media pages can be hosted on any domain or platform. The advertisements are populated within ad zones of various sizes and positions on the page. The ad zone can be compose of any HTML div, iframe, frame, or any other type that can load content dynamically or statically through client or server side scripts that alter the Document Object Model (DOM).

The ad server is responsible for delivering and optimizing the ad impressions displayed to visitors such that they produce the highest paying revenue (CPM). In some cases, depending on the number of ad impressions available and the total CPM, one configuration might be more preferable than another. The ad server can dynamically configure the layouts for the ad zones in order to optimize the number of advertisements and revenue generated.

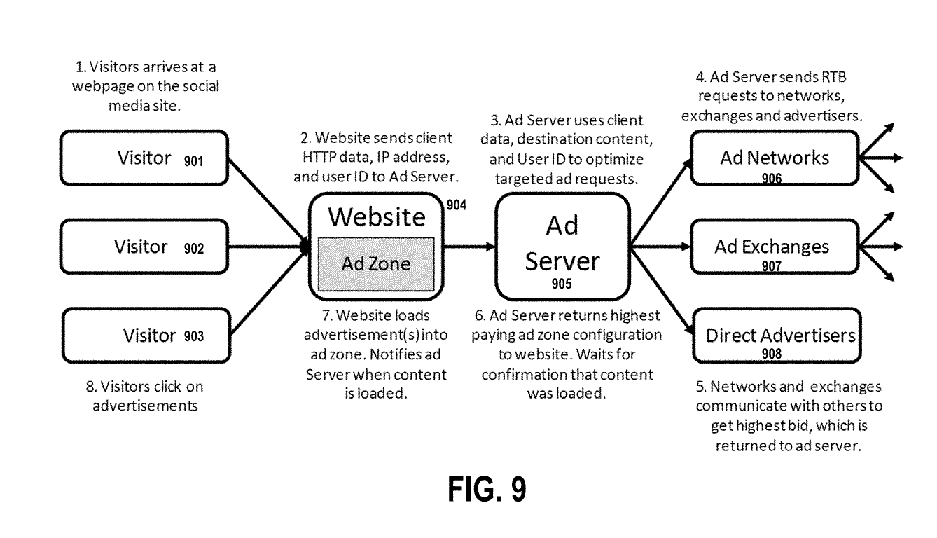

The ad serving methodology is described in FIG. 9 under an exemplary embodiment. The ad server acquires information about the user, including IP address, HTTP User Agent, and cookie data to identify the user (901-903). From this information, the client browser, operating system, geolocation, and hardware platform are derived. It also uses the context and meta data from the web page, such as the title, description, keywords, and headers, to target relevant advertisements which generally have higher revenue potential. For instance, content about cars would target an ad impression related to car companies. The unique user ID of the owner (publisher) may be also passed to the ad server 904 to facilitate branded advertisements for people of interest. The Ad Server processes this information 905 and sends request to various ad networks 906, ad exchanges 907 and direct advertisers 908 using a real-time-bidding system, where the highest bid(s) returned win. The Ad Server determines based on the bids returned the best configuration of the ad zone that maximizes the revenue potential. The configuration may be sent to the website to dynamically load the ad impressions and layout. The client browser should have Javascript enabled in their browser and no ad blockers enabled for the content to load successfully. Upon loading the ad content, the website notifies the Ad Server of its success. Subsequently, the Ad Server logs the ad impression as a paid advertisement and the owner's account may be credited.

The operations by the ad server include, but not limited to the following:
1. Use the content from the destination website, keywords, title, description, and categories to target advertisements based on the taxonomy, term, or category matching.
2. Target advertisements based on the specific unique publisher ID, This facilitates branded advertisements for celebrities, athletes and other persons of interest.
3. Determine from the HTTP User Agent if the client browser may be on a mobile platform that requires mobile size advertisements.
4. Track visitors with cookies containing a unique ID. The cookie never expires and may be never overwritten. The cookie's unique ID along with the IP address may be stored in a database, which may be used for frequency capping, to ensure an advertisement is not shown to the same visitor more than a specified amount.
5. Determine from the HTTP User Agent if the client browser or operating system are undefined, if the client is a web crawler or bot, or if the client is behind a proxy server. Advertisements are not shown or paid in these cases and client is redirected to the destination page.
6. Dynamically create DOM element and pixel tracking to determine if the Javascript is enabled. If not, it is a sign that the client might be a program not operating through a browser. Advertisements are not shown in this case.
7. Geo-IP location lookup is used for targeting advertisements to specific regions for anonymous visitors. The geolocation can be acquired from the accounts of those visitors who are logged in.

To meet the effective bandwidth requirements to process ad requests at this level of speed, the Ad Server algorithm was designed to utilize multi-threaded parallel processing methods. This allows the system to communicate with multiple platforms concurrently, as opposed to sequentially waiting for each one to return a value before proceeding to the next one. In [EX5] below, the C++ function passes in arguments to a parallel thread, one create for each ad network. The thread_function accepts the parameters as input and returns its highest bid and the link to the advertisement. The highest bid may be then chosen and returned by the application.

Finally, the event may be stored in the database for reporting and retrieval.

[EX5]: Multi-threaded process for communicating with
different ad networks.

```
// initialize and set thread detached attribute
pthread_attr_init( &attr );
pthread_attr_setdetachstate( &attr,
PTHREAD_CREATE_JOINABLE );
// create the threads
for ( int i = 0; i < NUM_NETWORKS; i++ )
{
    // pass in arguments to the thread
    args_in[i].network = i;
    args_in[i].mobile = params.mobile;
    strncpy( args_in[i].refid, params.refid.c_str( ), sizeof
(args_in[i].refid));
    strncpy( args_in[i].ip, params.ip.c_str( ), sizeof(args_in[i].ip) );
    strncpy( args_in[i].url, params.url.c_str( ), sizeof(args_in[i].url) );
    strncpy( args_in[i].browser, params.browser.c_str( ),
sizeof(args_in[i].browser) );
    // create a parallel thread to communicate with networks
```

| | |
|---|---|
| pthread_create( &tid[i], | // the pthread ID |
| &attr, | // default attributes |
| thread_function, | // function to |
| | communicate with ad |
| networks | |
| (void*)&args_in[i] ); | // arguments |
| } | |

```
// free attributes
pthread_attr_destroy( &attr );
// now wait for all threads to terminate
for ( int i = 0; i < NUM_NETWORKS; i++ )
{
    struct args_out_struct * args_out = NULL;
    valid[i] = false;
    cpv[i]= 0.0f;
    if ( pthread_join( tid[i], (void**)&args_out ) == 0 )
    {
        if ( args_out != NULL )
        {
            cpv[i] = args_out->cpv;
            valid [i] = args_out->valid;
            width[i]= args_out->width;
            height[i] = args_out->height;
            ad_url[i] = string(args_out->ad);
            free( args_out );
        }
    }
}
// get the max CPV and ad URL
for ( int i = 0; i < NUM_NETWORKS; i++ )
{
    if( valid[i] == true && cpv[i] > sel_cpv && cpv[i] > MIN_CPV )
    {
        sel_valid = true;
        sel_cpv = cpv[i];
        sel_height = height[i];
        sel_width = width[i];
        sel_url = ad_url[i];
        sel = i;
    }
}
// store the event in the database
if ( sel_valid == true )
{
    track_ad_event( mysql_inst, params.id, params.ip, params.tag,
sel_cpv, sel );
}
```

### (J) Targeted Advertisements

Advertisements can be targeted based on a variety of information. From visitors who are logged in, we can obtain information about from their account, interactions, and pages they visit. All this information can be utilized for targeting advertisements to their interests.

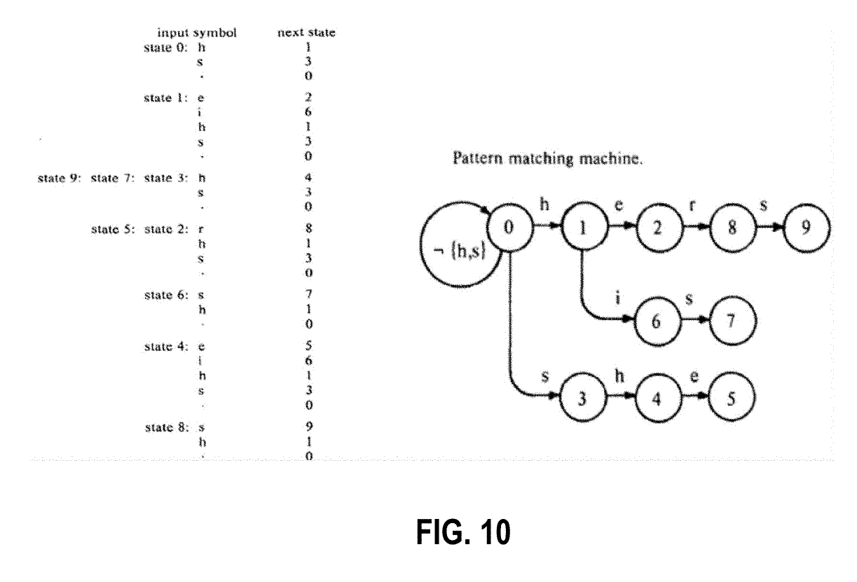

The content on the page, including title, description, keywords, and headers can be parsed to determine categories and keywords that of interest to advertisers. Using string matching based on the Aho-Corasick pattern matching algorithm in FIG. 10, one may apply finite-state-machine lookup tables to match patterns in linear time. The algorithm uses a database to match keywords to categories in order to determine the context of the data. The categories and keywords can then be passed to the ad serving platform to target advertisements for a particular page, or we can track users with cookies that suggest they have an interest in context about those subject matters. For instances, if the context of the page was about cars, the ad server can promote car advertisements. A cookie would then be dropped in the client's browser assigning categories=cars.

In statistics, Bayesian inference is a method of inference in which Bayes' theorem is used to update the probability estimate for a hypothesis as additional evidence is learned. What Bayes' theorem clearly demonstrated is that the more information given, the more accurate the view of the world will be, and prior experience should be used to inform new data. In a typical problem, such as judging the relevance of content to a given query, Bayesian theory dictates that this calculation be related to details that are already known. In a similar manner, knowledge about the content deemed relevant by a user can also be used in judging the relevance of future context or documents. In true Bayesian fashion, we begin with an empty data set and let the incoming data dictate the model. The new information is mixed with a growing body of older content to refine and retrain the engine.

Natural languages contain a high degree of redundancy or nonessential content. For example, the essence of a news article can be grasped simply by skimming over the text. Shannon's information Theory provides a framework for extracting the essential concepts from this redundancy, and serves as a mathematical foundation for all digital communications systems. The theory implies that the less frequently a unit of communication occurs, the more information it conveys. Therefore, ideas, which are rarer within the context of a communication, tend to be more indicative of its meaning. It is this theory that enables a content search engine to determine the most important or informative concepts or terms within the context of a document.

Applied to the task of information filtering, the idea is that the odds of a content being relevant to the topic profile is determined using a generative probabilistic language model. If the content scores above a user defined threshold then it is considered relevant to the topic profile. Content can be modeled as a bag of words consisting of terms t and the frequency f of occurrences of the term within the document. The term t can refer to a single word or a fixed sequence of words, or n-grain. A Bayesian algorithm can be computed offline to determine a set of weights w for each term, generally based on the frequency of occurrence in the natural language. The more frequent the term appears in the language, the lower the weight. For instance, the word occurs so often in the English language that it would have a very small weight. One way to calculate the weights would be to use a natural language processing learning machine to analyze a large number of documents and determine the frequency of the terms it encounters in the natural language. These weights can then be programmed in a parser to determine how relevant the content is in accordance with the search query. The score of a given content can be calculated as the summation of the frequency of occurrence of each term in the content, multiplied by its weight.

In this ad targeting technology, we parse the terms and words from the content of each page, title, description, keywords, and headers. We can then match the words to a database to quickly accumulate the frequency of occurrence for each individual word or n-gram. The low-frequency words can be extracted automatically and used for categorizing the context of the page and for optimizing targeted advertisements.

Advertisements are also targeted by matching the unique user ID. The unique user ID of the publisher of the content may be passed to the ad server during the redirect process in order to facilitate branded advertisements for people of interest. When a match is found, a branded ad campaign may take precedence over all other ad campaigns, regardless of a higher CPM bid from other ad networks or exchanges.

Furthermore, the demographics for celebrities and other persons of interest are generally more well-defined. For example, a female sing,erlsongwriter would statistically have a larger audience composed of females in a particular age range. One may utilize these statistics to profile the visitors, target specialize advertisements for those demographics, or apply the information to cookie tracking to acquire more analytical data in the future.

### (K) Security Features

The system screens out web crawlers, hots, clients behind a proxy server, and invalid traffic sources such as traffic exchanges. All of this information can be derived from behavior monitoring, content matching, database lookups, or third-party tool integration. In order to prevent fraud and abuse, if any of these checks turn out positive, the advertisement are not shown and the publisher does not earn revenue from those visits.

The system then uses the client IP address, HTTP user-agent, and referring URL to gather information about the client. This information includes but is not limited to browser, operating system, referring website, and geolocation. The traffic analytics data may be then stored to the database.

The system consists of several security features to prevent abuse from users who artificially inflate traffic to generate more revenue, target unsuspecting people with viruses or Trojans, or share illegal and inappropriate content. These security features monitor the behavior and data from incoming and outgoing traffic, and the contents of the destination. The following descriptions include, but are not limited to those security features employed:
1. Real-time threat protection against sharing malicious sites containing viruses, Trojans or malware. A third party tool or database can be used to obtain real-time statistics on any domain or webpage. For external queries to third-party tools, such as anti-virus solutions, a real-time database can be used to cache daily requests in order to avoid repeated external queries. If an active threat is found on a domain or page, the redirect to that page is prevented. Instead, visitors are notified that the page has been blocked.
2. Real-time protection against inappropriate material, adult content, illegal content, or potentially unsafe destinations. When a link shared, the meta data from the destination page is downloaded, including title, description, keywords, images, videos, and headers. The content is parsed and matched against specific keywords, such as those used in adult material. Images and videos can also be analyzed through learning machines, pattern matching algorithms, or skin detection algorithms to identify adult content, nude regions, or other inappropriate material. If one or more matches are found, the link can be flagged or blocked. Redirects to that page are prevented, and visitors are notified that the page has been blocked.
3. Real-time protection for traffic sources whose referring website domain or IP address originates from particular traffic-exchanges or other illegal sources. In such cases, these addresses can be blocked from seeing advertisements. Likewise, IP addresses from particular proxies, countries, or users can be blocked from seeing advertisements and generating ad revenue. The IP addresses and domain names can be stored in a local database and quickly retrieved.
4. Proxy server detection, which may be used to hide the true IP address and browser of the visitor. This is the typical method for software programs to exploit traffic, since the proxy server can flush out all session cookies and change its IP address instantaneously making it seem like a new visitor. Proxy servers can be detected by the existence of HTTP headers, such as HTTP_VIA, HTTP_FORWARDED, HTTP_USERAGENT_VIA, and HTTP_X_FORWARDED_FOR. However, some proxies do not abide by these standards. Other ways of detecting proxies is by querying third-party databases for known proxy servers.
5. Cookie tracking is used to identify those visitors who utilize hidden proxies or software programs to generate traffic. One may store previous IP addresses into a tracking cookie that is deposited in the client's browser. If not flushed, when the cookie is read back one can determine if the IP address had changed in a short period of time. This is a clear indication that a proxy is being used or the IP address is being altered by a software program. The use of zombie cookies, or ever-cookies, can also be employed to track a user more thoroughly. This is accomplished by storing the cookie data in several types of storage mechanisms that are available on the local browser. If any of the data is ever lost, the data can be recovered and then reset and reused.
6. Behavior monitoring may be used to identify whether a software program is being used to generate traffic. Generally software programs are very precise in the time between traffic hits. If a consistent pattern is identified, it may be an indication of a software program. Illegal behavior can also be identified by looking at the traffic analytics.
7. Generally, an imbalanced number of operating systems, browsers, or no referring websites is an indication that a software program is being used to generate the traffic.

Traffic patterns from social media sites have a very distinct characteristic. If a page has a large number of referrers from a particular social media site, but the traffic pattern does not fit the standard traffic pattern, it can be flagged as well.
8. Traffic patterns that show a large number of visits but very little advertisements may be an indication that Javascript is not running on the client browser. This can indicate that a software program or web crawler is generating the traffic because they cannot execute Javascript code outside a web browser.
9. If a user is found to abuse the system, advertisements can be disabled for the all pages on the account.

It should be understood by those skilled in the art that the disclosure provided herein provides advantages over existing computer system. Furthermore, the appendices accompanying the present disclosure provide further details regarding exemplary algorithmic processes for executing at least some of the techniques described herein. Again, it should be understood by those skilled in the art that the present disclosure is being provided for the purposes of illustration only, and should not be construed as limiting the present disclosure to the specific embodiments described. While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the invention in any way. Rather, the foregoing detailed description will provide those skilled in the art with a convenient and edifying road map for implementing the described embodiment or embodiments. Thus the following claims are hereby incorporated into the Detailed Description, with each claim standing on its own as a separate embodiment.

1.-11. (canceled)

12. A computer-implemented method for rewarding, through advertisement revenue, a content publisher who shares media content to a computer network for perception by an audience, the method comprising:
identifying at least one targeted advertisement from a plurality of available advertisements based on a relevance score, wherein the relevance score includes at least one of:
(i) a relevance score of the media content, wherein the relevance score of the media content is derived by analyzing the media content, using at least one of a machine learning method, a context method, a natural language method, a pattern matching method, a taxonomy matching method, a term matching method, an object or facial recognition method, or a category matching method, to determine relevancy of the media content to the plurality of available advertisements,
(ii) a relevance score of the content publisher, wherein the relevance score of the content publisher is derived by analyzing demographic information of the content publisher in relation to the plurality of available advertisements,
(iii) a relevance score of influence of the content publisher, wherein the relevance score of influence of the content publisher is derived by analyzing one or more of the following factors: website traffic, a number of n-degree connections to the content publisher, or audience engagement with the media content, wherein n≥1, or
(iv) a relevance score of the audience, wherein the relevance score of the audience content is derived by analyzing demographic information of the audience in relation to the plurality of available advertisements;
transmitting the at least one targeted advertisement for perception by the audience;
calculating a monetization score for the content publisher, wherein the calculation of the monetization score is based on at least one of the following factors: the relevance score, influence of the content publisher, the audience demographic information, audience interaction with the at least one targeted advertisement, revenue earned, or advertising rates,
calculating a monetization rank of the content publisher, wherein the monetization rank includes comparing the monetization score for the content publisher with a monetization score of other content publishers; and
for each transmitted targeted advertisement, rewarding the content publisher based on the monetization score and monetization rank of the content publisher.

13. The computer-implemented method of claim 12 wherein the demographic information of the content publisher includes at least one of media content previously shared by the content publisher, IP address, HTTP data, gender, age, ethnicity, geo-IP location, or interests.

14. The computer-implemented method of claim 12 wherein the demographic information of the audience includes at least one of previous website interactions, audience interactions, email address, profile picture, mailing address, gender, ethnicity, age, account settings, social media handles, or geo-IP location.

15. The computer-implemented method of claim 12 wherein the influence of the content publisher is derived from at least one of website traffic, a number of n-degree connections to the content publisher or audience engagement with the shared media content, wherein n≥1.

16. The computer-implemented method of claim 15 wherein audience engagement includes a number of views of the media content, audience comments, audience likes, audience shares, click-through rate, sign-ups, or audience traffic to the media content.

17. The computer-implemented method of claim 12 further comprising, after identifying the at least one targeted advertisement, selecting from the at least one targeted advertisement at least one selected targeted advertisement, wherein the selecting includes receiving a plurality of bids from at least one of a plurality of advertisement providers, wherein each of the plurality of bids comprises a value for the identified at least one targeted advertisement; and processing the plurality of bids to identify a highest bid corresponding to a highest value.

18. The computer-implemented method of claim 17 comprising transmitting the at least one selected targeted advertisement.

19. The computer-implemented method of claim 12 wherein the relevance score comprises the relevance score of the content publisher or the relevance score of the influence of the content publisher.

20. The computer-implemented method of claim 19 wherein the identifying the at least one targeted advertisement is performed by an advertiser.

21. The computer-implemented method of claim 12 wherein the plurality of available advertisements are selected from ad networks, ad exchanges, or direct advertisers.

22. The computer-implemented method of claim 12 wherein the content publisher shares the media content via a social media platform.

23. The computer-implemented method of claim 22 wherein the social media platform is configured to analyze data about each shared media content and each audience member perceiving the shared media content and thereafter, to display results of the analysis.

24. The computer-implemented method of claim 22 wherein the social media platform includes a content publisher network, wherein the content publisher network includes the content publisher and one or more n-degree connections, wherein the one or more n-degree connections include one or more followers of the content publisher, friends, visitors, businesses, or groups, and wherein n is ≥1.

25. The computer-implemented method of claim 24 wherein the social media platform displays the content publisher network as an interactive graphical structure or a neural network that is capable of showing events that occur with respect to the content publisher network, wherein the events include a new connection, a status update, a sharing of content, a comment, or a communication.

26. The computer-implemented method of claim 25 wherein the calculating of the monetization score further includes events that occur with respect to the content publisher network.

27. The computer-implemented method of claim 12 wherein the monetization score for each content publisher is calculated based on
S=Σₖ₌₀ⁿWₖ*Rₖ,
where Wₖ is the fractional weight for the at least one factor and Rₖ is a rank of the content publisher compared to a rank of other content publishers with respect to each of the at least one factor and is from 0-100% for each factor such that Σₖ₌₀ⁿWₖ=1.

28. The computer-implemented method of claim 12, further comprising validating the at least one targeted advertisement prior to transmitting the at least one targeted advertisement.

29. The computer-implemented method of claim 12 further comprising analyzing the calculated monetization score to derive a predicted monetization score based on one or more changes to the factors.

30. A system for rewarding, through advertisement revenue, a content publisher who shares media content to a computer network for perception by an audience, the system comprising:
a computer network that includes one or more user computers each having an electronic display;
a social media platform adapted to interact with the network and including a processor coupled to a non-transitory memory, wherein the processor is operative to execute computer program instructions to cause the processor to:
identify at least one targeted advertisement from a plurality of available advertisements based on a relevance score, wherein the relevance score includes at least one of:
(i) a relevance score of the media content, wherein the relevance score of the media content is derived by analyzing the media content, using at least one of a machine learning method, a context method, a natural language method, a pattern matching method, a taxonomy matching method, a term matching method, an object or facial recognition method, or a category matching method, to determine relevancy of the media content to the plurality of available advertisements,
(ii) a relevance score of the content publisher, wherein the relevance score of the content publisher is derived by analyzing demographic information of the content publisher in relation to the plurality of available advertisements,
(iii) a relevance score of influence of the content publisher, wherein the relevance score of influence of the content publisher is derived by analyzing one or more of the following factors: website traffic, a number of n-degree connections to the content publisher, or audience engagement with the media content, wherein n≥1, or
(iv) a relevance score of the audience, wherein the relevance score of the audience content is derived by analyzing demographic information of the audience in relation to the plurality of available advertisements;
transmit the at least one targeted advertisement for perception by the audience;
calculate a monetization score for the content publisher, wherein the calculation of the monetization score is based on at least one of the following factors: the relevance score, influence of the content publisher, the audience demographic information, audience interaction with the at least one targeted advertisement, revenue earned, or advertising rates;
calculate a monetization rank of the content publisher, wherein the monetization rank includes comparing the monetization score for the content publisher with a monetization score of other content publishers using the social media platform; and
for each transmitted targeted advertisement, reward the content publisher based on the monetization score and monetization rank of the content publisher.
